(19) United States
(12) Patent Application Publication
(10) Pub. No.: US 2011/0161628 A1
(43) Pub. Date: Jun. 30, 2011

(54) DATA PROCESSING APPARATUS AND METHOD OF CONTROLLING RECONFIGURABLE CIRCUIT LAYER

(75) Inventor: Minoru Suzuki, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/971,373

(22) Filed: Dec. 17, 2010

Related U.S. Application Data
(60) Provisional application No. 61/290,422, filed on Dec. 28, 2009.

(51) Int. Cl. G06F 15/76; G06F 9/02

(52) U.S. Cl. 712/32; 712/E09.002

(57) ABSTRACT

According to one embodiment, a data processing apparatus includes plural reconfigurable circuit layers, a first memory, a selecting unit, and a configuring unit. In each of the plural reconfigurable circuit layers, a processing circuit can be reconfigured. The first memory stores circuit information representing processing circuits that should be configured. The selecting unit selects, if it is unnecessary to use all the plural reconfigurable circuit layers in order to configure the processing circuits represented by the circuit information, a part of the reconfigurable circuit layers having high priority orders set in advance and otherwise selects all the plural reconfigurable circuit layers. The configuring unit configures, using the selected reconfigurable circuit layers, the processing circuits represented by the circuit information stored in the first memory.

### CROSS-REFERENCE TO RELATED APPLICATIONS

This application is based upon and claims the benefit of priority from U.S. provisional application 61/290,422, filed on Dec. 28, 2009, the entire contents of which are incorporated herein by reference.

### FIELD

Embodiments described herein relate generally to a data processing apparatus and a method of controlling a reconfigurable circuit layer.

### BACKGROUND

A stacked semiconductor device is put to practical use as a technique for realizing high-density packaging of a semiconductor circuit in a limited mountable area of a substrate. In recent years, the stacked semiconductor device is applied to various fields. However, this type of semiconductor device has low heat radiation efficiency because of a stacked structure formed by stacking plural chips in a package. Therefore, the temperature of the device rises according to an increase in speed and an increase in the number of stacked layers due to an increase in circuit size. Measures against malfunctions and failures due to such a temperature rise pose a problem.

As a related art for solving this problem, several proposals are already made. One of the proposals is addition of a heat radiation plate to a package of a semiconductor device. Another one of the proposals is contrivance of a connection method among stacked chips. All the proposals are proposals for improving heat radiation efficiency through contrivance of the structure of the semiconductor device and are not enough for eliminating the problem of heat radiation in realizing higher-speed operation and a further increase in circuit size.

In a semiconductor device having reconfigurable circuit layers in which circuits can be reconfigured, a working frequency is extremely high and heat generation is large. Therefore, measures against the large heat generation pose a significant problem.

### BRIEF DESCRIPTION OF THE DRAWINGS

FIG. 1 is a block diagram of a data processing apparatus according to a first embodiment;

FIG. 2 is a flowchart for explaining an operation in configuring a processing circuit of the data processing apparatus shown in FIG. 1;

FIG. 3 is a diagram of a first usage state of a reconfigurable circuit layer;

FIG. 4 is a diagram of a second usage state of the reconfigurable circuit layer;

FIG. 5 is a diagram of a third usage state of the reconfigurable circuit layer;

FIG. 6 is a flowchart for explaining an operation in a dynamic mode of the data processing apparatus shown in FIG. 1;

FIG. 7 is a diagram of an example of mounting areas of processing circuits before and after a change of the processing circuits;

FIG. 8 is a diagram of an example of the mounting areas of the processing circuits before and after the change of the processing circuits;

FIG. 9 is a block diagram of a data processing apparatus according to a second embodiment; and

FIG. 10 is a flowchart for explaining an operation in configuring a processing circuit of the data processing apparatus shown in FIG. 9.

### DETAILED DESCRIPTION

In general, according to one embodiment, a data processing apparatus includes: plural reconfigurable circuit layers, a first memory, a selecting unit, and a configuring unit. In each of the plural reconfigurable circuit layers, a processing circuit can be reconfigured. The first memory stores circuit information representing processing circuits that should be configured. The selecting unit selects, if it is unnecessary to use all the plural reconfigurable circuit layers in order to configure the processing circuits represented by the circuit information, a part of the reconfigurable circuit layers having high priority orders set in advance and otherwise selects all the plural reconfigurable circuit layers. The configuring unit configures, using the selected reconfigurable circuit layers, the processing circuits represented by the circuit information stored in the first memory.

Several embodiments are explained below with reference to the accompanying drawings.

### First Embodiment

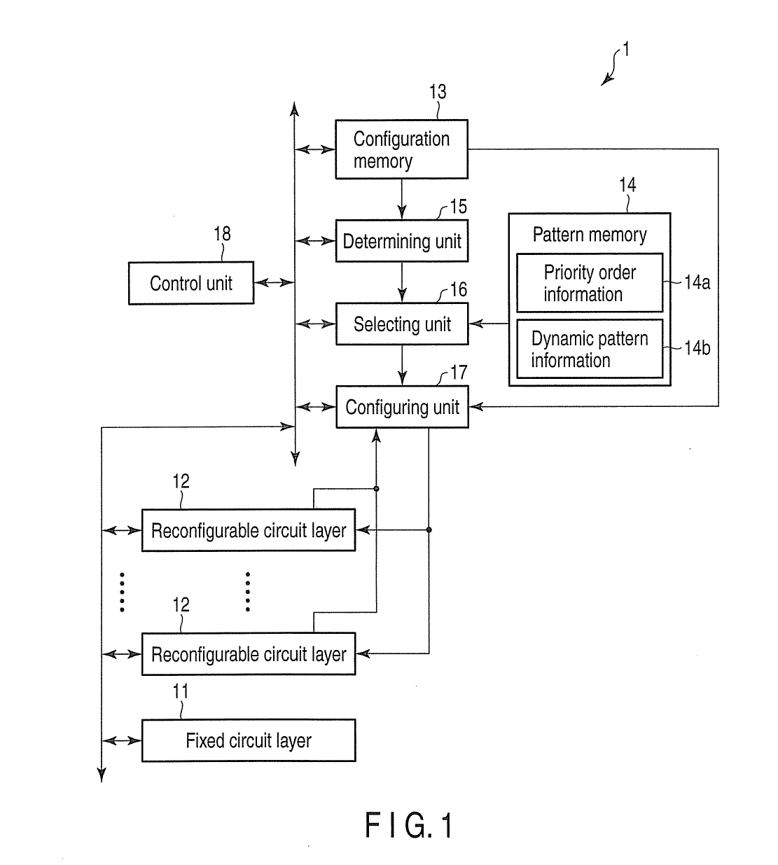

FIG. 1 is a block diagram of a data processing apparatus 1 according to a first embodiment. The data processing apparatus 1 includes, for example, a stacked semiconductor device of a BGA (ball grid array) package. The data processing apparatus 1 can be applied to processing of various data. As an example, the data processing apparatus 1 can be applied to image processing in a multi function peripheral (MFP).

The data processing apparatus 1 includes a fixed circuit layer 11, plural reconfigurable circuit layers 12, a configuration memory 13, a pattern memory 14, a determining unit 15, a selecting unit 16, a configuring unit 17, and a control unit 18.

The fixed circuit layer 11 and the plural reconfigurable circuit layers 12 are respectively circuit layers of semiconductors. The fixed circuit layer 11 and the plural reconfigurable circuit layers 12 are connected or wired to one another according to necessity and, as a whole, form a data processing chip such as an image processing chip.

In the fixed circuit layer 11, a processing circuit for performing data processing for realizing required functions in the MFP, to which the data processing apparatus 1 is applied, is fixedly configured. For example, an ASIC (application specific integrated circuit) is used for the fixed circuit layer 11.

In each of the plural reconfigurable circuit layers 12, a large number of circuit elements are two-dimensionally arrayed. Various processing circuits can be arbitrarily configured using these circuit elements as appropriate. In other words, in the reconfigurable circuit layer 12, a processing circuit to be mounted can be reconfigured.

A processing circuit configured in the reconfigurable circuit layer 12 typically includes plural circuit blocks. The plural circuit blocks are caused to cooperate with one another to function as one processing circuit. One circuit block needs to be configured in one reconfigurable circuit layer 12. Separate circuit blocks respectively configured in the different reconfigurable circuit layers 12 can cooperate with one another. In the first embodiment, such a usage form is a premise of the explanation.

The configuration memory 13 stores circuit information representing processing circuits configured on the plural reconfigurable circuit layers 12. The circuit information individually represents the configurations of the plural circuit blocks included in one processing circuit.

The pattern memory 14 stores priority order information 14a and dynamic pattern information 14b. The priority order information 14a represents priority orders of the plural reconfigurable circuit layers 12. The priority orders are set such that heat radiation efficiency concerning heat generation in processing circuits configured in at least a part of the plural reconfigurable circuit layers 12 is as high as possible. An arrangement pattern represented by the dynamic pattern information 14b represents which area of one reconfigurable circuit layer 12 is used in order to configure each of plural processing circuits that should be configured at different timings in the reconfigurable circuit layer 12. The priority orders and the arrangement pattern can be set taking into account, for example, actual arrangement states of the fixed circuit layer 11 and the plural reconfigurable circuit layers 12 and states around the fixed circuit layer 11 and the plural reconfigurable circuit layers 12 (e.g., arrangement states of spaces and members that can be used for heat radiation). This setting is desirably performed properly on the basis of objective information obtained by an experiment or a simulation. However, the setting may be performed on the basis of an empirical rule of a designer of the data processing apparatus 1.

The determining unit 15 determines a numerical value representing the size of respective circuits of the circuit blocks of the reconfigurable circuit layer 12 (hereinafter simply referred to as circuit size) on the basis of the circuit information stored in the configuration memory 13.

The selecting unit 16 selects, referring to the priority order information 14a, the reconfigurable circuit layer 12 in which the circuit blocks are configured. When it is necessary to change a processing circuit configured in one reconfigurable circuit layer 12 according to progress of processing, the selecting unit 16 selects, referring to the dynamic pattern information 14b, an area where the processing circuit is configured in the relevant reconfigurable circuit layer 12.

The configuring unit 17 configures each of the plural circuit blocks represented by the circuit information stored in the configuration memory 13 in the reconfigurable circuit layers 12 selected by the selecting unit 16 concerning the circuit blocks.

The control unit 18 includes a CPU (central processing unit) and a memory. The CPU operates according to a computer program written in the memory in advance, whereby the control unit 18 collectively controls the operation of the entire data processing apparatus 1 according to a procedure set in advance.

The operation of the data processing apparatus 1 is explained below.

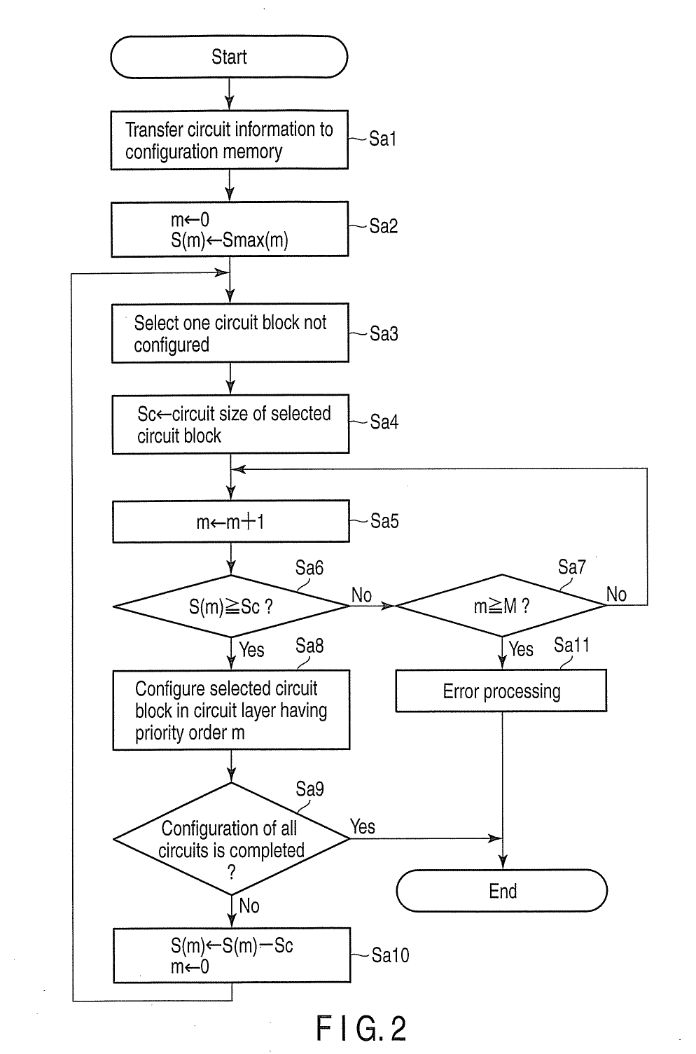

FIG. 2 is a flowchart for explaining the operation of the data processing apparatus 1 in configuring a processing circuit.

In Act Sa1, the control unit 18 transfers circuit information concerning a processing circuit to be configured to the configuration memory 13.

In Act Sa2, the control unit 18 initializes a variable m and a variable S(m) respectively to “0” and Smax(m). The variable m represents a priority order set in each of the plural reconfigurable circuit layers 12. The variable S(m) represents the size of a circuit that can be additionally configured in the reconfigurable circuit layer 12 having an mth priority order. Smax(m) represents the size of a circuit that can be configured in an initial state in the reconfigurable circuit layer 12 having the mth priority order (hereinafter referred to as maximum circuit size). Therefore, Smax(m) is a fixed value set from the structure of the reconfigurable circuit layer 12.

In Act Sa3, the control unit 18 selects one circuit block that is not configured in the reconfigurable circuit layer 12 among the plural circuit blocks included in the processing circuit represented by the circuit information stored in the configuration memory 13. The order of this selection may be order set in advance or may be random.

In Act Sa4, the control unit 18 sets the circuit size concerning the selected circuit block in a variable Sc. Specifically, the control unit 18 instructs the determining unit 15 to determine the circuit size concerning the selected circuit block. According to this instruction, the determining unit 15 analyzes the circuit information stored in the configuration memory 13 and determines the circuit size concerning the selected circuit block. The control unit 18 receives the determined circuit size from the determining unit 15 and sets the circuit size in the variable Sc.

In Act Sa5, the selecting unit 16 increases the variable m by one.

In Acts Sa6 and Sa7, the selecting unit 16 checks whether the variable S(m) is equal to or larger than the variable Sc or whether the variable m is equal to or larger than a numerical value M. The numerical value M is the number of the reconfigurable circuit layers 12 included in the data processing apparatus 1. If the variable S(m) is not equal to or larger than the variable Sc and the variable m is not equal to or larger than the numerical value M, the selecting unit 16 returns to Act Sa5.

In this way, the selecting unit 16 searches for the variable m with which the variable S(m) is equal to or larger than the variable Sc while increasing the variable m from “0” by one at a time until the variable m reaches the numerical value M. Consequently, the reconfigurable circuit layer 12 is selected that has the highest priority order among the reconfigurable circuit layers 12 in which the sizes of circuits that can be additionally configured are larger than the circuit size of the selected circuit block.

When the variable S(m) is equal to or larger than the variable Sc, the selecting unit 16 gives the variable m to the configuring unit 17.

In Act Sa8, the configuring unit 17 configures the selected circuit block in the reconfigurable circuit layer 12 having the priority order “m”. In other words, the configuring unit 17 sets the selected circuit block in the reconfigurable circuit layer 12 selected by the selecting unit 16 as explained above.

In Act Sa9, the control unit 18 checks whether configuration of all the circuit blocks represented by the circuit information is completed. If the configuration of all the circuit blocks is not completed, the control unit 18 proceeds from Act Sa9 to Act Sa10.

In Act Sa10, the control unit 18 sets a value obtained by subtracting the variable Sc from the variable S(m) in the variable S(m). The control unit 18 sets 0 in the variable m. Thereafter, the control unit 18 returns to Act Sa3. Consequently, the operation explained above is repeated targeting another circuit block not configured yet.

If the configuration of all the circuit blocks is completed, in Act Sa9, the data processing apparatus 1 exits a processing loop of Act Sa1 to Act Sa10 and ends the operation shown in FIG. 2.

If, in the processing loop of Act Sa5 to Act Sa7, the selecting unit 16 cannot select the reconfigurable circuit layer 12 in which the selected circuit block can be configured and the variable m exceeds the numerical value M, the selecting unit 16 notifies the control unit 18 to that effect.

In response to this notification, in Act Sa11, the control unit 18 performs error processing. The error processing is, for example, processing for notifying an apparatus on which the data processing apparatus 1 is mounted that the circuit information is not proper. When the error processing is completed, the data processing apparatus 1 ends the operation shown in FIG. 2.

According to the operation explained above, basically, the circuit blocks are configured in order from the reconfigurable circuit layer 12 having the highest priority order.

It is specifically explained below how the plural reconfigurable circuit layers 12 are used according to the circuit size of the processing circuit.

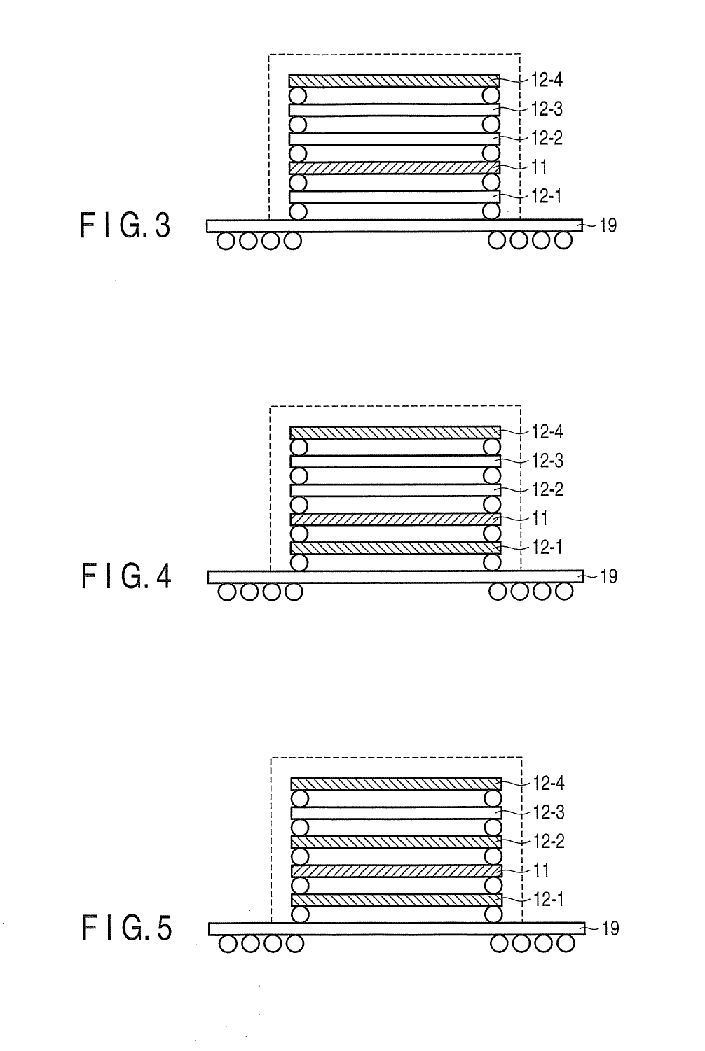

It is assumed that the number of the reconfigurable circuit layers 12 is four and the reconfigurable circuit layers 12 are distinguished by affixing reference signs 12-1, 12-2, 12-3, and 12-4 thereto. It is assumed that the fixed circuit layer 11 and the reconfigurable circuit layers 12-1 to 12-4 are stacked in order shown in FIG. 3. Reference numeral 19 in FIG. 3 denotes a substrate. A broken line in FIG. 3 represents a contour of a package. Specifically, a bottom layer is the reconfigurable circuit layer 12-1 and the fixed circuit layer 11, the reconfigurable circuit layer 12-2, the reconfigurable circuit layer 12-3, and the reconfigurable circuit layer 12-4 are stacked above the reconfigurable circuit layer 12-1 in this order. It is assumed that priority orders are set in the order of the reconfigurable circuit layer 12-4, the reconfigurable circuit layer 12-1, the reconfigurable circuit layer 12-2, and the reconfigurable circuit layer 12-3 taking into account various conditions. The conditions include conditions explained below. (1) Heat radiation efficiency of a portion close to the upper surface or the lower surface of the package is high. (2) Since the layers mounted with the circuits are not adjacent to each other, heat radiation efficiency is higher. (3) Since a working frequency is higher in the reconfigurable circuit layers 12 than the fixed circuit layer 11, heat radiation efficiency is low when the reconfigurable circuit layers 12 mounted with the circuits are adjacent to each other than when the reconfigurable circuit layer 12 and the fixed circuit layer 11 mounted with the circuits are adjacent to each other.

Under the conditions explained above, if the circuit size of the processing circuits represented by the circuit information (hereinafter referred to as set circuit size) is smaller than the maximum circuit size of the reconfigurable circuit layer 12-4, as shown in FIG. 3, the processing circuits represented by the circuit information are mainly mounted on the reconfigurable circuit layer 12-4. In FIG. 3, the circuit layers that operate for image processing are indicated by hatching.

If the set circuit size is equal to or larger than the maximum circuit size of the reconfigurable circuit layer 12-4 and smaller than a sum of the maximum circuit sizes of the reconfigurable circuit layers 12-4 and 12-1, as shown in FIG. 4, the processing circuits represented by the circuit information are mainly mounted on the reconfigurable circuit layers 12-4 and 12-1. In FIG. 4, the circuit layers that operate for image processing are indicated by hatching.

If the set circuit size is equal to or larger than the sum of the maximum circuit sizes of the reconfigurable circuit layers 12-4 and 12-1 and smaller than a sum of the maximum circuit sizes of the reconfigurable circuit layers 12-4, 12-1, and 12-2, as shown in FIG. 5, the processing circuits represented by the circuit information are mainly mounted on the reconfigurable circuit layers 12-4, 12-1, and 12-2. In FIG. 5, the circuit layers that operate for image processing are indicated by hatching.

If the set circuit size is equal to or larger than the sum of the maximum circuit sizes of the reconfigurable circuit layers 12-4, 12-1, and 12-2, the processing circuits represented by the circuit information are mounted on all the reconfigurable circuit layers 12-4, 12-1, 12-2, and 12-3.

Consequently, if it is possible to configure the processing circuit using only a part of the plural reconfigurable circuit layers 12, the processing circuit is mounted on the reconfigurable circuit layer 12 selected to improve heat radiation efficiency. Therefore, it is possible to suppress heat generation in the entire data processing apparatus 1.

The data processing apparatus 1 has a dynamic mode for dynamically changing a configuration state of the processing circuit in one reconfigurable circuit layer 12 according to the progress of processing.

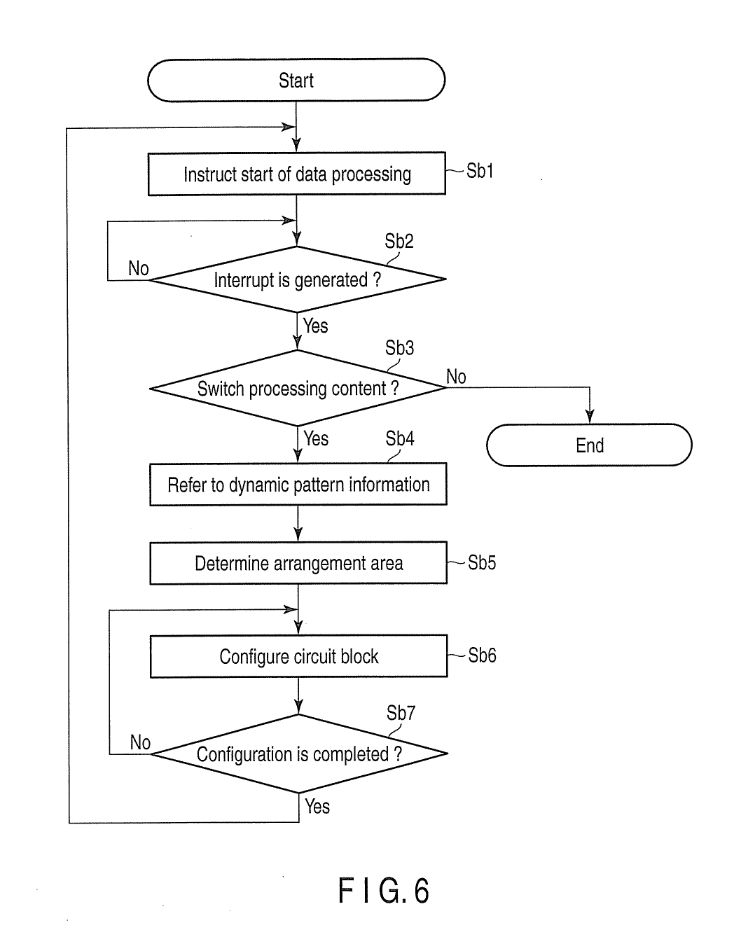

FIG. 6 is a flowchart for explaining the operation of the data processing apparatus 1 in the dynamic mode. The operation shown in FIG. 6 is performed targeting one reconfigurable circuit layer 12. The operation shown in FIG. 6 may be individually performed targeting the respective reconfigurable circuit layers 12 according to necessity.

The operation shown in FIG. 6 is started after the configuration of the processing circuits in the plural reconfigurable circuit layers 12 is completed by the operation explained above.

In Act Sb1, the control unit 18 gives an instruction to the processing circuits configured in the plural reconfigurable circuit layers 12. The processing circuits execute predetermined processing according to the instruction. When the processing is completed, the processing circuits output an interrupt signal to the control unit 18. The interrupt signal includes information for recognizing what kind of processing is completed.

Therefore, in Act Sb2, the control unit 18 waits for the interrupt signal to arrive. When the interrupt signal arrives, the control unit 18 proceeds to Act Sb3.

In Act Sb3, the control unit 18 determines on the basis of the interrupt signal whether it is necessary to switch processing content. If the control unit 18 can confirm that it is necessary to switch the processing content, the control unit 18 notifies the selecting unit 16 and the configuring unit 17 to that effect. According to the notification, the operation of the data processing apparatus 1 proceeds from Act Sb3 to Act Sb4.

In Act Sb4, the selecting unit 16 refers to the dynamic pattern information 14b.

In Act Sb5, the selecting unit 16 determines, on the basis of the dynamic pattern information 14b, areas where the processing circuits after change are mounted. The selecting unit 16 notifies the configuring unit 17 of the determined areas.

In Acts Sb6 and Sb7, the configuring unit 17 configures the circuit blocks included in the processing circuits after the change one by one until the configuration of all the circuit blocks is completed. Areas where the circuit blocks are configured are areas determined by the selecting unit 16 as explained above.

If the configuring unit 17 finishes configuring all the circuit blocks, the operation of the data processing apparatus 1 returns to Act Sb1.

According to the operation explained above, the areas where the respective processing circuits are mounted are changed before and after the change. The processing circuits may be the same or may be different before and after the change.

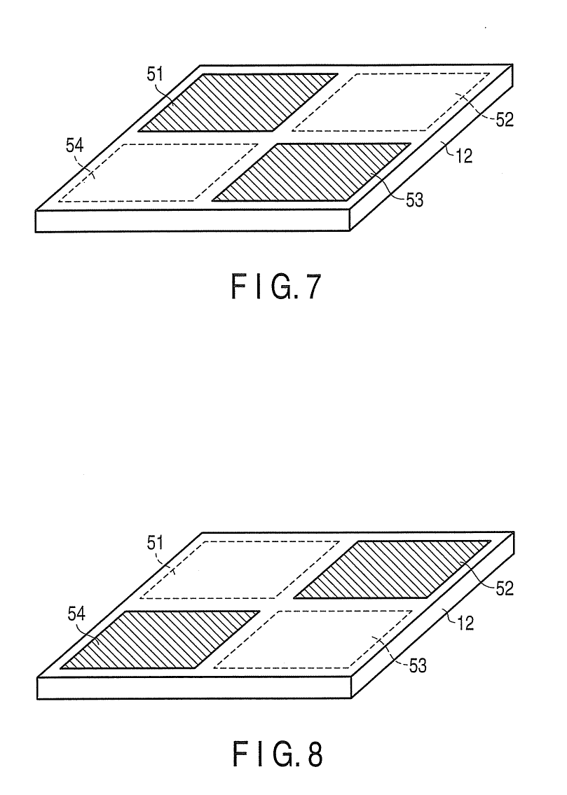

FIGS. 7 and 8 are diagrams of examples of the mounting areas of the processing circuits before and after the change of the processing circuits.

In the examples, the reconfigurable circuit layer 12 is imaginarily divided into four areas 51, 52, 53, and 54. In a first state, as shown in FIG. 7, the processing circuits are mounted on the areas 51 and 53. In a second state, as shown in FIG. 8, the processing circuits are mounted on the areas 52 and 54. In FIGS. 7 and 8, the areas where the processing circuits are mounted are indicated by hatching.

In the examples shown in FIGS. 7 and 8, the size of the processing circuits before the change and the size of the processing circuits after the change are substantially equal. However, when the processing circuits are different before and after the change, in some case, it is possible that the size of the areas where the processing circuits are mounted is different. In FIGS. 7 and 8, the circuit mounting areas before and after the change do not overlap one another. However, in some case, it is possible that parts of the circuit mounting areas overlap one another.

In this way, the areas where the processing circuits are mounted in the reconfigurable circuit layer 12 are changed. This makes it possible to prevent heat generated by the processing circuits from being concentratedly accumulated in the same area and efficiently radiate heat. Therefore, it is possible to suppress heat generation in the entire data processing apparatus 1.

### Second Embodiment

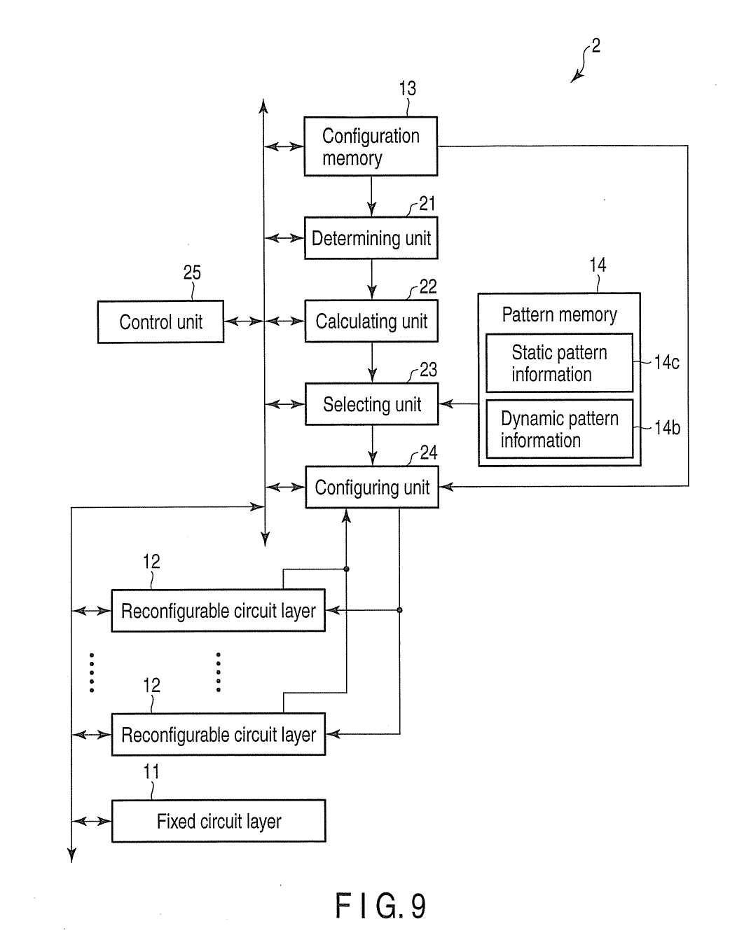

FIG. 9 is a block diagram of a data processing apparatus 2 according to a second embodiment. In FIG. 9, components same as those in FIG. 2 are denoted by the same reference numerals and signs and detailed explanation of the components is omitted. Like the data processing apparatus 1, the data processing apparatus 2 includes, for example, a stacked semiconductor device of a BGA package. The data processing apparatus 2 can be applied to processing of various data. As an example, the data processing apparatus 2 can be applied to image processing in an MFP.

The data processing apparatus 2 includes the fixed circuit layer 11, the plural reconfigurable circuit layers 12, the configuration memory 13, the pattern memory 14, a determining unit 21, a calculating unit 22, a selecting unit 23, a configuring unit 24, and a control unit 25. In other words, the data processing apparatus 2 includes the determining unit 21, the selecting unit 23, the configuring unit 24, and the control unit 25 instead of the determining unit 15, the selecting unit 16, the configuring unit 17, and the control unit 18 in the data processing apparatus 1 and includes the calculating unit 22.

The data processing apparatus 2 and the data processing apparatus 1 are the same in many aspects. Therefore, differences from the data processing apparatus 1 are mainly explained below. Explanation of similarities is omitted.

The pattern memory 14 stores static pattern information 14c instead of the priority order information 14a. The static pattern information 14c represents, in association with a usage ratio, which of the plural reconfigurable circuit layers 12 is used for configuration of a processing circuit. It is possible to set, for example, taking into account actual arrangement states of the fixed circuit layer 11 and the plural reconfigurable circuit layers 12 and states around the fixed circuit layer 11 and the plural reconfigurable circuit layers 12 (e.g., arrangement states of spaces and members that can be used for heat radiation), which reconfigurable circuit layer 12 is used with respect to which usage ratio. This setting is desirably performed properly on the basis of objective information obtained by an experiment or a simulation. However, the setting may be performed on the basis of an empirical rule of a designer of the data processing apparatus 2.

The determining unit 21 determines, on the basis of the circuit information stored in the configuration memory 13, the size of the entire processing circuits set in the plural reconfigurable circuit layers 12 (hereinafter referred to as total circuit size).

The calculating unit 22 calculates a usage ratio as a ratio of the total circuit size to a predetermined configurable size. The configurable size is the maximum size of circuits that can be configured in an initial state of the plural reconfigurable circuit layers 12.

The selecting unit 23 selects, on the basis of the usage ratio and the static pattern information, the reconfigurable circuit layer 12 used for configuring processing circuits out of the plural reconfigurable circuit layers 12. Like the selecting unit 16, the selecting unit 23 also has a function of selecting areas where the processing circuits are configured in the reconfigurable circuit layer 12 referring to the dynamic pattern information 14b.

The configuring unit 24 configures each of the plural circuit blocks represented by the circuit information stored in the configuration memory 13 in the reconfigurable circuit layer 12 selected by the selecting unit 16.

The control unit 25 includes a CPU and a memory. The CPU operates according to a computer program written in the memory in advance, whereby the control unit 25 collectively controls the operation of the entire data processing apparatus 2 according to a procedure set in advance.

The operation of the data processing apparatus 2 is explained below.

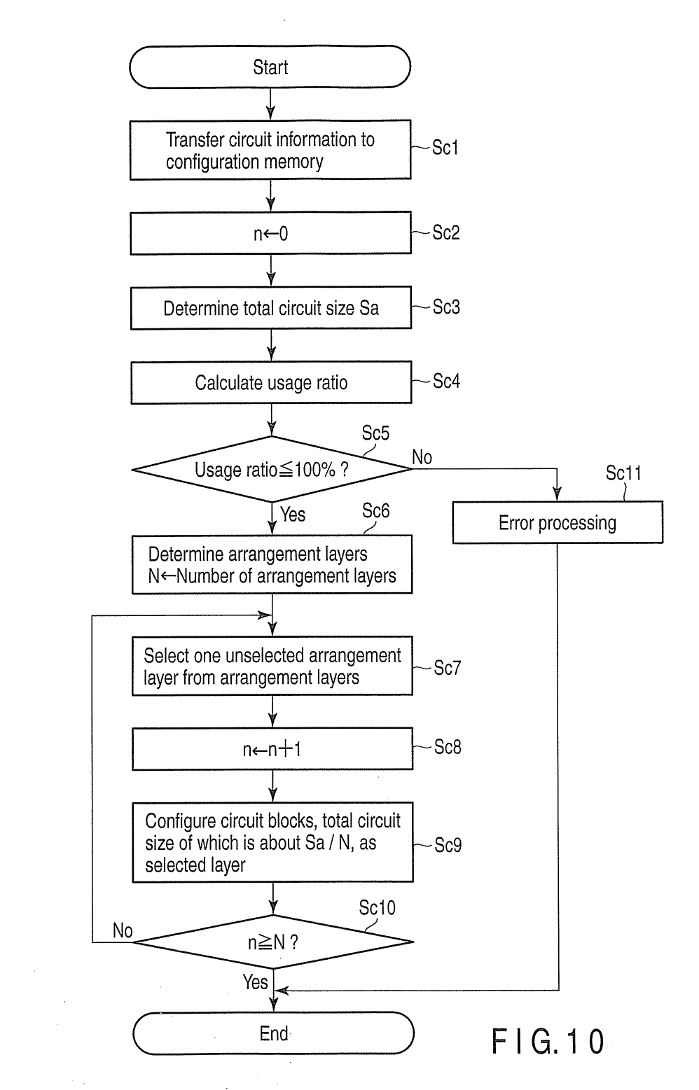

FIG. 10 is a flowchart for explaining the operation of the data processing apparatus 2 in configuring a processing circuit.

In Act Sc1, the control unit 25 transfers circuit information concerning a processing circuit to be configured to the configuration memory 13.

In Act Sc2, the control unit 25 initializes a variable n to “0”. The variable n represents the number of the reconfigurable circuit layers 12 in which configuration of circuit blocks is performed.

In Act Sc3, the determining unit 21 determines, on the basis of the circuit information stored in the configuration memory 13, total circuit size Sa of the processing circuits represented by the circuit information.

In Act Sc4, the calculating unit 22 calculates a usage ratio as a ratio of the total circuit size Sa to configurable size.

In Act Sc5, the selecting unit 23 checks whether the calculated usage ratio is equal to or lower than 100%. If the usage ratio is equal to or lower than 100%, the selecting unit 23 proceeds from Act Sc5 to Act Sc6.

In Act Sc6, the selecting unit 23 determines one or plural arrangement layers on the basis of the calculated usage ratio and the static pattern information 14c and sets the number of determined arrangement layers in a variable N. The arrangement layers indicate the reconfigurable circuit layers 12 used for configuring circuit blocks.

In Act Sc7, the selecting unit 23 selects unselected one arrangement layer among the arrangement layers.

In Act Sc8, the control unit 25 increases the variable n by one.

In Act Sc9, the configuring unit 24 selects plural circuit blocks, the total circuit size of which is a value approximate to a value calculated by Sa/N, out of the plural circuit blocks represented by the circuit information. The configuring unit 24 configures the selected circuit blocks in the selected reconfigurable circuit layers 12.

In Act Sc9, the control unit 25 checks whether the variable n is equal to or larger than the variable N. If the variable n is smaller than the variable N, the data processing apparatus 2 repeats the operation in Act Sc7 and subsequent acts. Consequently, the circuit blocks are sequentially configured in the one reconfigurable circuit layer 12 determined as the arrangement layer or each of the plural reconfigurable circuit layers 12 determined as the arrangement layers.

If the configuration of the circuit blocks in all the reconfigurable circuit layers 12 determined as the arrangement layers is completed, in Act Sc10, the control unit 25 determines that the variable n is equal to or larger than the variable N. Then, the data processing apparatus 2 ends the operation shown in FIG. 10.

If the calculated usage ratio exceeds 100%, the control unit 25 proceeds from Act Sc5 to Act Sc11. In Act Sc11, the control unit 25 performs error processing. The error processing is, for example, processing for notifying an apparatus on which the data processing apparatus 2 is mounted that the circuit information is not proper. When the error processing is completed, the data processing apparatus 2 ends the operation shown in FIG. 10.

According to the operation explained above, if it is unnecessary to use all the plural reconfigurable circuit layers 12 in order to configure plural circuit blocks included in a processing circuit, the processing circuit is mounted using the reconfigurable circuit layers 12 having higher heat radiation efficiency among the plural reconfigurable circuit layers 12.

It is specifically explained below how the plural reconfigurable circuit layers 12 are used according to the usage ratio.

It is assumed that the reconfigurable circuit layers 12-1 to 12-4 are stacked in the order shown in FIG. 3. It is assumed that the maximum sizes of circuits that can be configured in the initial state in the reconfigurable circuit layers 12-1 to 12-4 are equal to one another.

In this case, it is assumed that the static pattern information 14c represents, for example, a relation between the usage ratio and the arrangement layers explained below.

Usage ratio≦25%: the reconfigurable circuit layer 12-4.

25%<usage ratio≦50%: the reconfigurable circuit layers 12-1 and 12-4.

50%<usage ratio≦75%: the reconfigurable circuit layers 12-1, 12-2, and 12-4.

75%<usage ratio: the reconfigurable circuit layers 12-1, 12-2, 12-3, and 12-4.

Then, as in the first embodiment, the reconfigurable circuit layers 12 having high heat radiation efficiency are preferentially used.

Various modifications of this embodiment explained below are possible.

The data processing apparatus 2 does not have to include the fixed circuit layer 11.

The operations explained in the embodiment are examples only. As a result, it is sufficient that circuits can be preferentially configured in the reconfigurable circuit layers 12 having higher heat radiation efficiency. A detailed procedure for the configuration can be changed as appropriate.

In the dynamic mode, three or more circuit configuration states can be switched. In this case, configuration areas of circuits may be set different in all the circuit configuration states. The configuration areas of the circuits may be set different only in a part of the circuit configuration states from the other circuit configuration states.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data processing apparatus comprising:
plural reconfigurable circuit layers, in each of which a processing circuit can be reconfigured;
a first memory configured to store circuit information representing processing circuits that should be configured;
a selecting unit configured to select, if it is unnecessary to use all the plural reconfigurable circuit layers in order to configure the processing circuits represented by the circuit information, a part of the reconfigurable circuit layers having high priority orders set in advance and otherwise select all the plural reconfigurable circuit layers; and
a configuring unit configured to configure, using the selected reconfigurable circuit layers, the processing circuits represented by the circuit information stored in the first memory.

2. The apparatus of claim 1, wherein the priority orders are set in advance taking into account heat radiation efficiency of heat generation in the data processing apparatus.

3. The apparatus of claim 2, further comprising at least one fixed circuit layer in which a processing circuit is fixedly configured, wherein
the priority orders are set in advance, taking into account heat radiation efficiency of heat generation in the data processing apparatus in a state of the fixed circuit layer is arranged in the data processing apparatus.

4. The apparatus of claim 1, wherein
the selecting unit selects one reconfigurable circuit layer having the highest priority order out of the reconfigurable circuit layers in which processing circuits are not configured yet,
the configuring unit configures at least a part of the processing circuits represented by the circuit information in the selected one reconfigurable circuit layer, and
the selecting unit repeats the selection of one reconfigurable circuit layer until all the processing circuits represented by the circuit information can be configured by the configuring unit in the selected reconfigurable circuit layers.

5. The apparatus of claim 1, further comprising:
a second memory configured to store, in association with a usage ratio of the plural reconfigurable circuit layers, pattern information representing an arrangement pattern that specifies which of the plural reconfigurable circuit layers should be used; and
a unit configured to calculate the usage ratio of the plural reconfigurable circuit layers on the basis of the circuit information stored in the first memory, wherein
the selecting unit selects, on the basis of the pattern information stored in the second memory in association with the calculated usage ratio, at least one reconfigurable circuit layer to be used out of the plural reconfigurable circuit layers.

6. A data processing circuit comprising:
a reconfigurable circuit layer in which a processing circuit can be reconfigured arbitrarily using a large number of circuit elements arrayed two-dimensionally;
a first memory configured to store circuit information representing plural processing circuits that should be respectively configured at different timings;
a second memory configured to store, in association with each of the plural processing circuits represented by the circuit information stored in the first memory, pattern information representing an arrangement pattern that specifies, taking into account heat radiation, which area of the reconfigurable circuit layers is used in order to configure the processing circuit;
a selecting unit configured to select, according to an implementation state of processing in the reconfigurable circuit layer, one of the plural processing circuits represented by the circuit information stored in the first memory;
a unit configured to determine, on the basis of the pattern information stored in the second memory, which area of the reconfigurable circuit layer is used in order to configure the selected processing circuit; and
a unit configured to configure the selected processing circuit using the circuit element located in the determined area among the large number of circuit elements.

7. The apparatus of claim 6, wherein the selecting unit reselects, according to output of an interrupt signal from the processing circuits configured in the reconfigurable circuit layer, one of the plural processing circuits represented by the circuit information stored in the first memory.

8. A method of controlling plural reconfigurable circuit layers in which respective processing circuits can be reconfigured, the method comprising:
calculating a usage ratio of the plural reconfigurable circuit layers on the basis of circuit information stored in a first memory and representing processing circuits that should be configured;
selecting at least one reconfigurable circuit layer to be used out of the plural reconfigurable circuit layers on the basis of pattern information stored in a second memory in association with the usage ratio of the plural reconfigurable circuit layers and representing an arrangement pattern that specifies, taking into account heat radiation, which of the plural reconfigurable circuit layers should be used; and
configuring the processing circuits represented by the circuit information stored in the first memory using the selected at least one reconfigurable circuit layer.

9. A method of controlling plural reconfigurable circuit layers in which respective circuit circuits can be configured, the method comprising:
selecting, when it is unnecessary to use all the plural reconfigurable circuit layers in order to configure processing circuits represented by circuit information stored in a first memory, a part of the reconfigurable circuit layers having high priority orders set in advance and otherwise selecting all the plural reconfigurable circuit layers; and
configuring the processing circuits represented by the circuit information stored in the first memory using the selected reconfigurable circuit layers.

10. A method of controlling a reconfigurable circuit layer in which a processing circuit can be reconfigured arbitrarily using a large number of circuit elements two-dimensionally arrayed, the method comprising:
selecting, according to an implementation state of processing in the reconfigurable circuit layer, one of plural processing circuits represented by circuit information stored in a first memory and representing the plural processing circuits that should be respectively configured at different timings;
determining, on the basis of pattern information stored in a second memory in association with each of the plural processing circuits represented by the first information stored in the first memory and representing an arrangement pattern that specifies in advance which area of the reconfigurable circuit layer is used in order to configure the processing circuits, which area of the reconfigurable circuit layer is used in order to configure the selected processing circuit; and
configuring the selected processing circuit using the circuit element located in the determined area among the large number of circuit elements.

11. The method of claim 9, wherein one of the plural processing circuits represented by the circuit information stored in the first memory is reselected according to output of an interrupt signal from the processing circuits configured in the reconfigurable circuit layer.
